(19) United States
(12) Patent Application Publication
(10) Pub. No.: US 2007/0131299 A1
(43) Pub. Date: Jun. 14, 2007

(54) Insulated duct wrap

(75) Inventor: Lynda Mae Kornbleet, Houston, TX (US)

Correspondence Address: ELIZABETH R. HALL, 1722 MARYLAND STREET, HOUSTON, TX, 77006, US

(73) Assignee: Superior Air Ducts, Houston, TX (US)

(21) Appl. No.: 11/302,680

(22) Filed: Dec. 14, 2005

(51) Int. Cl. F16L 9/14

(52) U.S. Cl. 138/149

(57) ABSTRACT

A flexible duct wrap comprising an insulation layer laminated with a vapor permeable outer layer. The duct wrap is used to reduce energy consumption and noise and to prohibit the premature failure of the duct wrap due to the concentration of moisture within the duct wrap.

### BACKGROUND OF THE INVENTION

1. Field of the Invention

The present invention relates to an air duct wrap used as an external insulation on heating or air conditioning ducts. In particular, the invention relates to a duct wrap having a permeable outer layer for use in insulating air ducts.

2. Description of the Related Art

Air conditioning systems for heating and/or cooling air are typically provided with cooling and heating equipment by which ambient air is heated or cooled depending upon the particular need. The heated or cooled air is then forced by an air handler of some type through air ducting for distribution to areas where needed, e.g. the rooms of a residence or commercial building.

Often large air ducts, particularly in commercial buildings, are rectangular or round sheet metal. Such air ducts provide little insulative value at the interface of the ambient air and the conditioned air forced through the duct. Thus, it is a common practice to insulate air ducts with a duct wrap to prevent heat transfer between the air flowing through the ducts and the ambient air surrounding the ducts. Insulating the air ducts assists in energy conservation, noise control, and condensation control.

The most commonly used duct wrap is a flexible fiberglass insulative blanket that is applied to the exterior of sheet metal ducts. It is easily cut and fitted to achieve an insulation blanket over rectangular, round, oval or irregularly shaped duct surfaces. The duct wrap is made of a liner of insulative material laminated to a moisture impermeable vapor barrier on the external surface.

Condensation forms on the metal air ducts wherever the duct surface reaches the dewpoint. The moisture may remain in place due to the vapor barrier encouraging microbial growth and moisture damage. The duct wrap is likely to become a moisture trap because of poor installation, taped joint failure, inefficient insulation, or damage to the vapor barrier where the warm moist ambient air is allowed to come in contact with cool air in contact with the metal air ducts.

There is a need in the industry for a duct wrap that will not act as a moisture trap and thereby prevent the destructive effects of condensation.

### SUMMARY OF THE INVENTION

The present invention provides a flexible duct wrap comprising an insulation layer laminated with a vapor permeable outer layer. The duct wrap is used to reduce energy consumption and noise and to prohibit the premature failure of the duct wrap due to the concentration of moisture within the duct wrap. One embodiment has an insulation layer made of a porous fibrous material and an outer layer made of a pair of sheets of porous material having a strengthening mesh sandwiched between the two sheets.

One aspect of the present invention is a duct wrap for insulating air conditioning and heating ducts comprising: (a) an insulation layer, and (b) a vapor permeable outer layer.

Another aspect of the present invention is an air duct for air conditioning and heating systems comprising: (a) an inner layer providing a continuous bore for the air duct, the inner layer having an inner liner, an external liner, and a support member embedded between and bonded to the inner liner and the external liner; (b) an insulation layer of plant-derived fibrous material surrounding the inner layer; and (c) an outer layer surrounding the insulation layer for protecting the air duct, the outer layer comprising a mesh material sandwiched between an upper and a lower tape wrap.

Yet another aspect of the present invention is a heat-insulating, noise-reducing air duct comprising: (a) an inner layer providing a continuous bore for the air duct, the inner layer having an inner liner composed of a porous cellulose-containing material, an external liner, and a spirally wound coil member positioned between the inner liner and the external liner; (b) an insulation layer, a principal ingredient of the insulation layer being cellulose, wherein the insulation layer surrounds the inner layer; and (c) an outer layer surrounding the insulation layer for protecting the air duct, wherein the exterior surface of the outer layer is reflective.

Still yet another aspect of the present invention is an air duct suitable for incorporation into the walls of buildings and residences, the air duct comprising: (a) an inner layer providing a continuous bore for an air duct, the inner layer having an inner liner, an external liner, a spirally wound metallic coil member positioned between the inner liner and the external liner, and an adhesive for adhering the inner liner, the external liner and the coil member together; (b) an insulation layer of a plant derived material surrounding the inner layer, the insulation layer having a density of at least 2.0 pounds per cubic inch; and (c) an outer layer surrounding the insulation layer for protecting the air duct, the outer layer comprising a mesh material sandwiched between an upper and a lower tape wrap.

Additional features and advantages of the invention will be described hereinafter which form the subject of the claims of the invention. It should be appreciated by those skilled in the art that the conception and the specific embodiments disclosed might be readily utilized as a basis for modifying or redesigning the method or process for carrying out the same purposes as the invention. It should be realized that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an oblique view of a duct having an insulation layer and an outer layer; and

FIG. 2 shows an oblique view of the outer layer with the top sheet and mesh partially peeled back.

### DESCRIPTION OF THE ILLUSTRATIVE EMBODIMENTS

Metal air ducts provide little acoustical or thermal insulative value causing problems with condensation on the surface of the ducts. Thus, it is a common practice to insulate air ducts with a duct wrap to prevent heat transfer between the air flowing through the ducts and the ambient air surrounding the ducts. Insulating the air ducts assists in energy conservation, noise control, and condensation control.

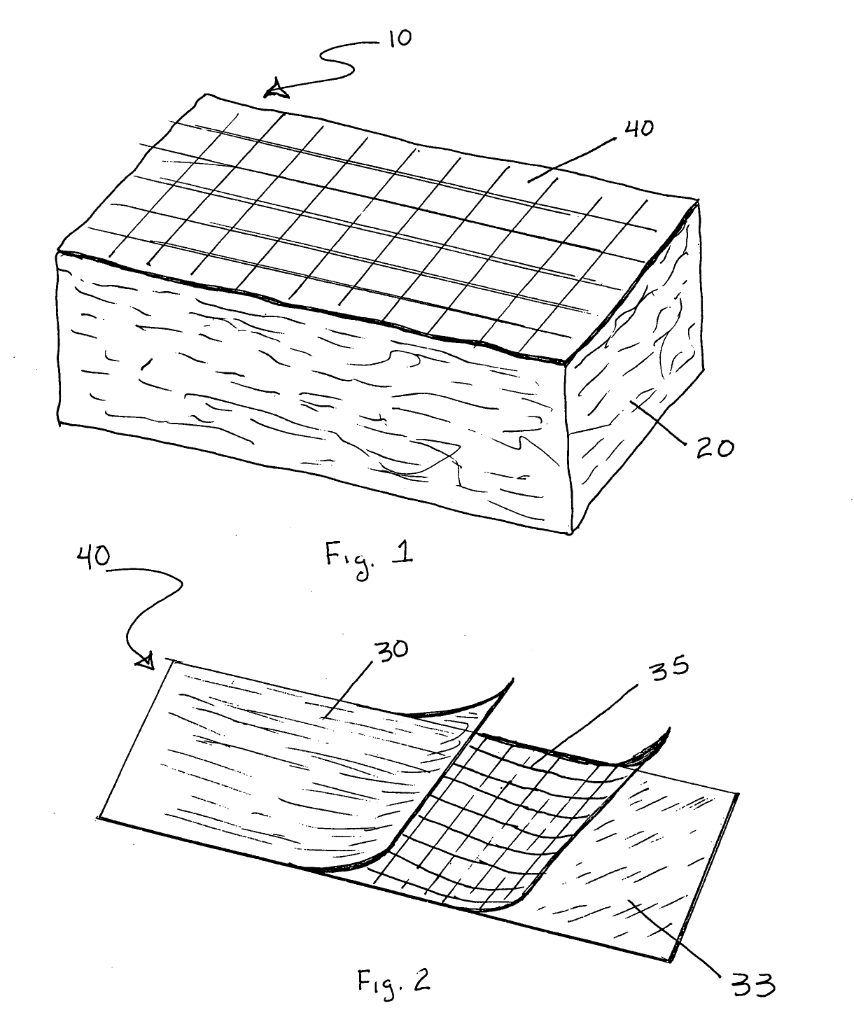

The most commonly used duct wrap is made of a fiberglass liner of insulative material laminated to a vapor barrier on the external surface. In contrast, the present invention provides a flexible duct wrap 10 having an insulation layer 20 and a vapor permeable outer layer 40 as illustrated in FIG. 1.

The insulation layer 20 and the permeable outer layer are joined together using an adhesive. Preferably an environmentally friendly flame retardant, flame resistant adhesive is used. In addition, the adhesive usually contains borate that resists fungal growth. The adhesive may be an epoxy or a pressure-, heat- or uv-activated adhesive. Furthermore, the insulation layer 20 may be treated with a water resistant material.

In the present invention the insulation layer 20 is a layer of heat insulation material that provides resistance to heat transfer. The term R-value refers to this resistance to heat transfer between the conditioned air passing through the ducting and the unconditioned or ambient air surrounding the ducting. Fiberglass batting is the most common insulative material used; however, recently natural fibrous materials, such as described in U.S. Pat. No. 6,425,419, have begun to replace fiberglass batting.

The common use of fiberglass batting in the insulative layer raises significant safety and health issues. Fiberglass has been identified as a possible carcinogen and OSHA requires workers handling fiberglass insulation materials to wear protective clothing and respirator masks for protection from the fiberglass particles that break loose during handling.

The duct wrap 10 is installed to surround air ducts. The duct wrap is a flexible material suitable for enclosing the exterior of rectangular or round sheet metal ducts and spaces or surfaces where temperature and condensation must be controlled.

The insulation layer 20 is preferably a layer of plant-derived fibrous material that takes the place of the typical fiberglass batting material of prior art. The preferred material is cotton. However, any suitable cellulose based material may be used, such as hemp, flax, cotton, kapok, jute, and combinations of such materials. The cotton batting (or other natural fibers) are preferably treated with a borate-containing fire retardant with flame resistant properties.

One advantage of the natural fiber batting insulation is that it is non-hazardous and non-carcinogenic. In addition, the natural fiber batting has greater insulating properties than the fiberglass batting insulation. For example, a typical cotton batting having a density of about 1.85 pounds/cubic foot has an R-value of 3.6 per inch of thickness for cotton as compared to fiberglass that has an R-value of about 2.0 to 2.5 per inch of thickness. An R-value defines the resistance to heat transfer and is a numeric value expressed in units of hr/Btu-ft.² /F°.

Preferred embodiments of the present invention do not use normal cotton batting, but use a special order cotton batting having a density greater than 2.0 pounds/foot³. Commonly available cotton batting has a maximum density of about 1.85 pounds/cubic foot. A preferred insulation in the present invention is a cotton batting having a 2.2 pound/foot³ density. The higher density cotton batting provides a significantly higher thermal resistance value of R8 or greater at a 2 inch thickness.

The duct wrap 10 of the present invention has a vapor permeable outer layer 40 that surrounds and protects the insulation layer 20. In contrast, all currently available duct wrap has a vapor impermeable outer layer that serves as a vapor barrier. The vapor barrier used in currently available duct wrap is commonly made of a thin metalized sheet, such as Mylar, and strengthened with a polyester or nylon scrim. It is commonly believed that the vapor barrier is required to control the condensation.

The present invention uses a vapor permeable outer layer 20. In many cases, the inventor has found that the use of a vapor barrier over a fiberglass batting in a duct wrap will actually create a moisture trap whenever warm moist air comes into contact with the cooled metal duct such that the air trapped within the duct wrap is cooled below the dew point temperature of the air causing condensation to occur within the duct wrap. For example, the duct wrap that is currently available can become a moisture trap because of poor insulation value, taped joints failing and puncture holes that allow the warm outside air to come in contact with the metal duct and the cool air surrounding the metal duct. Once condensation is formed and moisture trapped within the duct wrap because of the vapor barrier, moisture continues to accumulate further accelerating the failure of the duct wrap.

In the present invention the outer layer 40 is made of a vapor permeable material such that if condensate were to form the moisture would be able to vaporize and escape through the outer layer 40, preventing the premature failure of the duct wrap 10 and/or the leaking of water onto the floor of the attic causing moisture damage to the ceiling. Particularly when the insulation layer 20 is composed of a natural fiber material, or cellulose-based material, the insulation will wick any moisture that forms close to the metal air ducts or within the duct wrap toward the outer layer 40. The vapor permeable outer layer 40 will then allow the moisture to vaporize, thereby keeping the insulation layer 20 dry.

In the present invention, the outer layer 40 may be made of a variety of materials, as long as the outer layer 40 is vapor permeable. For example, the outer lining 40 could be made of a thin porous metal tape such as a stainless steel or aluminum tape. The outer lining 40 may also be made of a metalized sheet, such as Mylar, made vapor permeable by having a number of pores in the Mylar sheet. The size and number of pores is varied with the type of insulation, the R value of the insulation, and the range of temperatures anticipated for the ambient air and for the conditioned air passing through the air duct. In addition, the outer layer 40 can be made of one or more vapor permeable Mylar sheets strengthened with a synthetic mesh such as a polyester or nylon scrim.

However, the outer layer 40 is preferably made of one or more layers of a synthetic or natural fibrous material that is porous and permeable to air. For example, one or more synthetic materials such as nylon, polyester, polyethylene, or polystyrene may be used in the outer layer 40, or natural plant-derived materials such as rubber, paper, hemp, flax, cotton, kapok, and jute may be used in the outer layer 40. For example, one or more layers of linen or paper stock may be used to make the outer layer 40.

As shown in FIG. 2, the outer layer 40 can be two vapor permeable synthetic or natural fiber sheets 30 and 33 strengthened with a synthetic or natural fiber mesh material 35 sandwiched between the two vapor permeable sheets. The mesh material may be made of a synthetic material such as a polyester or nylon scrim, or the mesh material may be made of a natural material such as rubber or cotton gauze. The top or exterior sheet 30, the mesh 35, and the bottom or interior sheet 33 are typically joined together using an adhesive. Generally the adhesive is placed on the bottom surface of the exterior sheet, facing the mesh material, or on the upper surface of the interior sheet facing the mesh material.

Preferably an environmentally friendly flame retardant, flame resistant adhesive is used that contains borate and resists fungal growth. The adhesive may be an epoxy or a pressure-, heat-or uv-activated adhesive.

While preferred embodiments of the invention have been described herein, many variations thereof will be apparent to those skilled in the art without departing from the spirit of the invention. Accordingly, it is intended that the scope of the invention be limited only by the claims which follow.

What is claimed is:

1. A duct wrap for insulating air conditioning and heating ducts comprising (a) an insulation layer and (b) a vapor permeable outer layer.

2. The duct wrap of claim 1, wherein the insulation layer comprises one or more of the following materials: paper, cotton, flax, hemp, kapok, and jute.

3. The duct wrap of claim 1, wherein the outer layer comprises one or more of the following materials: metal, nylon, polyester, polyethylene, polystyrene, rubber, paper, cotton, flax, hemp, kapok, and jute.

4. The duct wrap of claim 1, wherein the insulation layer and the outer layer include a plant-derived fibrous material.

5. The duct wrap of claim 1, wherein the insulation layer is treated with a flame resistant material.

6. The duct wrap of claim 1, wherein the insulation layer is treated with a borate-containing material.

7. The duct wrap of claim 1, wherein the insulation layer is made of a cotton batting having a density greater than 2.0 pounds per cubic inch.

8. The duct wrap of claim 1, wherein the outer layer comprises an exterior sheet and an interior sheet with a mesh material sandwiched between the exterior and interior sheets.

9. The duct wrap of claim 8, wherein the mesh material is a synthetic scrim.

10. The duct wrap of claim 8, wherein the exterior and interior sheets are made of a plant-derived material.

11. The duct wrap of claim 8, wherein the exterior sheet has an adhesive on a bottom surface facing the mesh material or the interior sheet has an adhesive on an upper surface facing the mesh material.

12. The duct wrap of claim 11, wherein the adhesive is heat-activated.

13. The duct wrap of claim 8, wherein the exterior or interior sheet are made of a synthetic material.

14. The duct wrap of claim 13, wherein the synthetic material is a porous metalized sheet.

15. A duct wrap for insulating air conditioning and heating ducts comprising:
(a) an insulation layer made of a plant-derived material; and
(b) a vapor permeable outer layer.

16. The duct wrap of claim 15, wherein the insulation layer comprises one or more of the following materials: paper, cotton, flax, hemp, kapok, and jute.

17. The duct wrap of claim 15, wherein the outer layer comprises one or more of the following materials: metal, nylon, polyester, polyethylene, polystyrene, rubber, paper, cotton, flax, hemp, kapok, and jute.

18. The duct wrap of claim 15, wherein the insulation layer is made of a cotton batting having a density greater than 2.0 pounds per cubic inch.

19. The duct wrap of claim 15, wherein the outer layer comprises an exterior sheet and an interior sheet with a mesh material sandwiched between the exterior and interior sheets.

20. The duct wrap of claim 19, wherein the mesh material is a synthetic scrim.

21. The duct wrap of claim 19, wherein the exterior and interior sheets are made of a plant-derived material.

22. The duct wrap of claim 19, wherein the exterior sheet has an adhesive on a bottom surface facing the mesh material or the interior sheet has an adhesive on an upper surface facing the mesh material.

23. The duct wrap of claim 22, wherein the adhesive is heat-activated.

24. The duct wrap of claim 19, wherein the exterior or interior sheet are made of a synthetic material.

25. The duct wrap of claim 24, wherein the synthetic material is a porous metalized sheet.

26. A duct wrap for insulating air conditioning and heating ducts comprising:
(a) an insulation layer made of a plant-derived material; and
(b) a vapor permeable outer layer having an exterior sheet and an interior sheet and a synthetic mesh material sandwiched between the exterior sheet and interior sheet.
